(19) United States
(12) Patent Application Publication
(10) Pub. No.: US 2009/0326881 A1
(43) Pub. Date: Dec. 31, 2009

(54) MULTI-OBJECTIVE OPTIMAL DESIGN IMPROVEMENT SUPPORT DEVICE, ITS METHOD AND STORAGE MEDIUM

(75) Inventors: Hirokazu Anai, Kawasaki (JP); Hitoshi Yanami, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/424,212

(22) Filed: Apr. 15, 2009

(30) Foreign Application Priority Data
Jun. 27, 2008 (JP) 2008-168320

(51) Int. Cl. G06F 17/10; G06G 7/48

(52) U.S. Cl. 703/2; 703/7

(57) ABSTRACT

A multi-objective optical design improvement support device calculates a logical expression indicating a logical relationship among arbitrary two or three objective functions of a plurality of mathematically approximated objective functions and displays a possibility area in arbitrary objective space according to it. When a designer is not satisfied with an optimal Pareto solution, it copies a sample point group out of the initial constraints of a design parameter set in the objective space, displays its result and presents an improvement solution to the designer. When the designer finds more optimal solution than the optimal Pareto solution among the displayed improvement solutions and gives instruction, it calculates a sample point in design parameter space, corresponding to the optimal improvement solution, overlaps it with a constraint range and displays it as improvement knowledge and information.

### CROSS-REFERENCE TO RELATED APPLICATION

This application is based upon and claims the benefit of priority of the prior Japanese Patent Application No. 2008-168320, filed on Jun. 27, 2008, the entire contents of which are incorporated herein by reference.

### FIELD OF THE INVENTION

The embodiments discussed herein are related to a multi-objective optimal design support technique used in designing.

### BACKGROUND OF THE INVENTION

Along with the promotion of the high-density/high-capacity of hard disks, a distance between a magnetic disk and a header has decreased more and more. Thus, slider design, in which the amount of fly change due to an altitude difference and a disk radius position is small, is demanded.

As illustrated as 1601 in FIG. 16, a slider is installed at the tip bottom of an actuator 1602 which moves on a magnetic disk of a hard disk and the position of a header is calculated on the basis of the shape of the slider 1601.

When determining the optimal shape of the slider 1601, efficient calculation for minimizing the functions of fly height (1603 in FIG. 16), roll (1604) and pitch (1605) simultaneously which are related to the position of a header, so-called multi-objective optimization is needed.

Conventionally, instead of directly handling a multi-objective optimization subject, single-objective optimization, in which the linear sum f of terms obtained by multiplying each objective function f_i by weight m i is calculated and its minimum value is calculated is performed as follows.

f=m_{—}1*f_{—}1+ . . . +m_{—}t*f_t (Mathematical expression 1)

Then, while changing their values of parameters p, q, r and the like, for determining a slider shape S illustrated in FIG. 17 little by little by a program, a slider shape is calculated in such a way that the value f may become a minimum.

f depends on a weight vector {m_}. In actual calculation, while further changing {m_i}, the minimum value of f for each changed value is calculated and a slider shape is determined by comprehensively determining balance between the minimum value and {m_i}.

In such a multi-objective optimization process performed by the above-described method, the number of calculated optimal solutions is not always one.

For example, when optimizing an objective function value 1 of “reducing weight” and an objective function value 2 of “suppressing costs” in designing a certain product, the objective function values 1 and 2 can take various coordinate values on a two-dimensional coordinate as illustrated in FIG. 18, depending on how to give design parameters.

Both the objective function values 1 and 2 are required to take small values (light and low cost). Therefore, points on and in the neighborhood of a line 1803 connecting calculated points 1801-1, 1801-2, 1801-3, 1801-4 and 1801-5 illustrated in FIG. 18 can be a group of optimal solutions. These are called optimal Pareto solutions. Of these calculated points, the points 1801-1 and 1801-5 correspond to a model in which weight is reduced but cost is not suppressed and a model in which cost is suppressed but weight is not reduced, respectively. On the other hand, the calculated points 1802-1 and 1802-2 cannot become optimal solutions since either weight or cost can be still reduced. These are called inferior solutions.

In this way, in a multi-objective optimization process, it is very important to appropriately obtain Pareto solutions. For that purpose, it is very important to appropriately visualize Optimal Pareto solutions in a desired objective function.

Patent Document 1: Japanese Laid-open Patent Publication No. H11-242690

### SUMMARY OF THE INVENTION

The embodiments discussed herein are related to a design support device, method, or program for supporting the determination of an optimal design parameter set by inputting a plurality of sets of design parameters (input parameters) calculating a plurality of objective functions according to a prescribed calculation and performing a multi-objective optimization process of the plurality of objective functions.

The first aspect has the following configuration.

An objective space display unit displays an area in which the value of an arbitrary objective function can exist as a possibility area in objective space corresponding to the object function on the basis of the plurality of objective function sets calculated in relation to a plurality of design parameter sample sets.

A design parameter improvement candidate setting unit sets the design parameter set as a design parameter improvement candidate under improvement constraints other than the initial constraints of the design parameter corresponding to the possibility area in a design parameter space determined by an arbitrary design parameter according to the instruction of a user.

An improvement solution candidate calculation unit calculates an objective function corresponding to the design parameter improvement solution candidate as an improvement solution candidate.

An improvement candidate display unit displays the improvement solution candidate together with the possibility area in the objective space.

An optimal design parameter improvement candidate acquisition unit enables a user to select an optimal improvement solution candidate from the improvement solution candidates displayed by the improvement solution candidate display unit and obtains a design parameter set in the design parameter space corresponding to the optimal improvement solution candidate as an optimal design parameter improvement solution candidate.

A design parameter improvement knowledge/information presentation unit presents the improvement knowledge/information of a design parameter on the basis of the optimal design parameter improvement candidate. This unit presents a relationship between the design parameter possibility area and the optimal design parameter improvement candidate as improvement knowledge/information, for example, by overlapping the design parameter possibility area being an area determined by the initial constraints of a design parameter with the optimal design parameter improvement candidate and displaying them.

The configuration of the first aspect can further include an improvement constraint modification unit for modifying improvement constraints of the design parameter improvement candidate setting unit.

The second aspect has the following configuration.

A sample set objective function calculation unit calculates a plurality of objective function sets corresponding to a prescribed number of design parameter sample sets.

An objective function approximation unit mathematically approximates the objective functions on the basis of the prescribed number of design parameter sample sets and a plurality of objective function sets calculated in relation to them.

An inter-objective function logical expression calculation unit calculates a logical expression indicating a logical relationship among arbitrary objective functions of the plurality of mathematically approximated objective functions as an inter-objective function logical expression.

An objective space display unit displays an area in which the arbitrary objective function value can exist, as a possibility area in objective space corresponding to the arbitrary objective function, according to the inter-objective function logical expression.

Its design parameter improvement candidate setting unit, improvement solution candidate calculation unit, improvement solution candidate display unit, optimal design parameter improvement candidate acquisition unit, design parameter improvement knowledge/information presentation unit and improvement constraint modification unit are the same as those of the first aspect.

The object and advantages of the invention will be realized and attained by means of the element and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is the functional block configuration of this preferred embodiment;

FIG. 2 is an operational flowchart illustrating the processes of an actual fly calculation execution unit 101 and an objective function polynomial approximation unit 102;

FIG. 3 is an operational flowchart illustrating the processes of an objective function selection unit, an inter-objective function logical expression calculation unit and an objective function display unit (No. 1);

FIG. 4 is an overall operational flowchart illustrating the design support process in the preferred embodiment;

FIG. 5 is a further detailed operational flowchart illustrating the improvement solution search/reverse image display process;

FIG. 6 illustrates an input parameter sample set and each objective function value example corresponding to it;

FIG. 7 illustrates a possibility area display example (No. 1);

FIG. 8 illustrates a possibility area display example (No. 2);

FIGS. 9A and 9B illustrate a possible area display example (No. 3);

FIG. 10 explains the merit of possibility area display on the mathematical process base;

FIG. 11 explains the improvement solution search/reverse image display process (No. 1);

FIG. 12 explains the improvement solution search/reverse image display process (No. 2);

FIG. 13 explains the improvement solution search/reverse image display process (No. 3);

FIGS. 14A through 14C explain the improvement solution search/reverse image display process (No. 4);

FIG. 15 illustrates a hardware configuration example of a computer capable of realizing a system according to this preferred embodiment;

FIG. 16 explains the slider of a hard disk;

FIG. 17 explains the parameters of a slider shape;

FIG. 18 explains multi-objective optimization; and

FIG. 19 is an operational flowchart illustrating the conventional multi-objective optimizing operation.

### DESCRIPTION of THE PREFERRED EMBODIMENTS

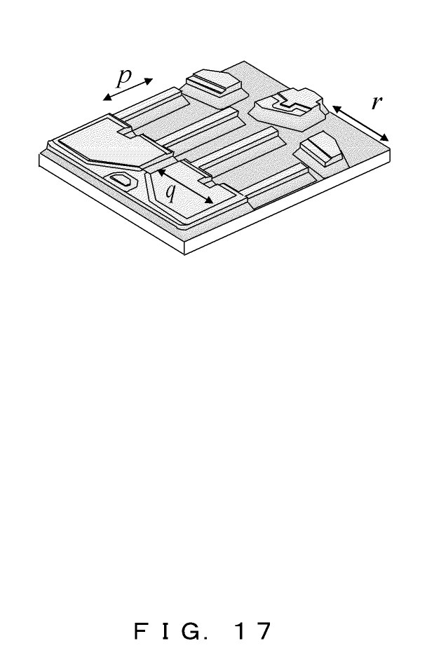

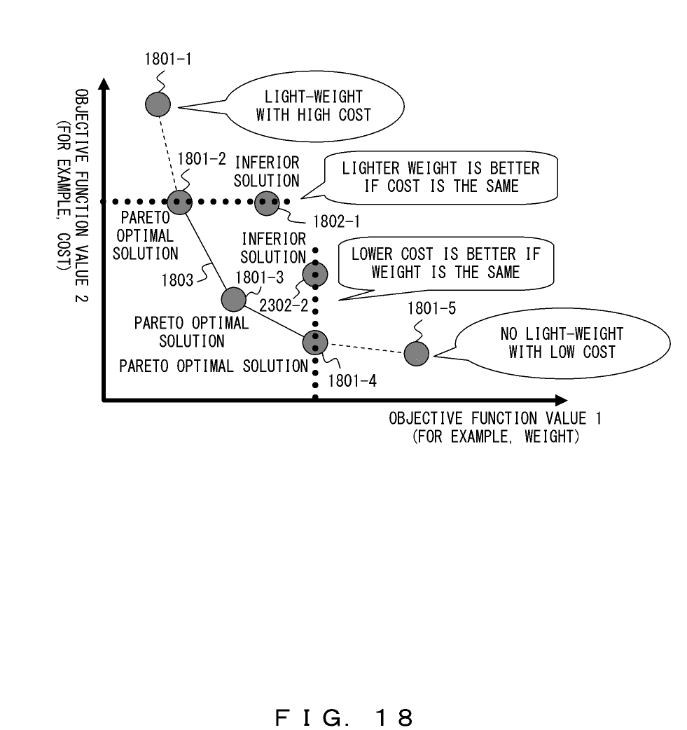

In the optimization technique of the earlier-described single-purpose function f, it is necessary to repeat time-taking fly calculation. Especially, when searching the fine part of a slider shape, the number of input parameters (corresponding to p, q, r and the like in FIG. 17) reaches approximately 20 and ten thousand or more times of fly calculation are needed. Therefore, optimization takes very much time.

In this technique, the minimum value of f (and an input parameter value at that time) depends on how to determine weight vectors (m_1, . . . m_t). In actual design, f is frequently desired to be optimized and compared for various sets of weight vectors. However, in the prior art, since it is necessary to conduct optimization calculation accompanying expensive fly calculation again from the beginning every time a weight vector is modified, the type of weight vectors to experiment is limited.

In the minimization of a function value f, since only one point can be obtained on a Pareto curved surface at one time, it is difficult to predict an optimal relationship among objective functions and also such information cannot be fed back to design.

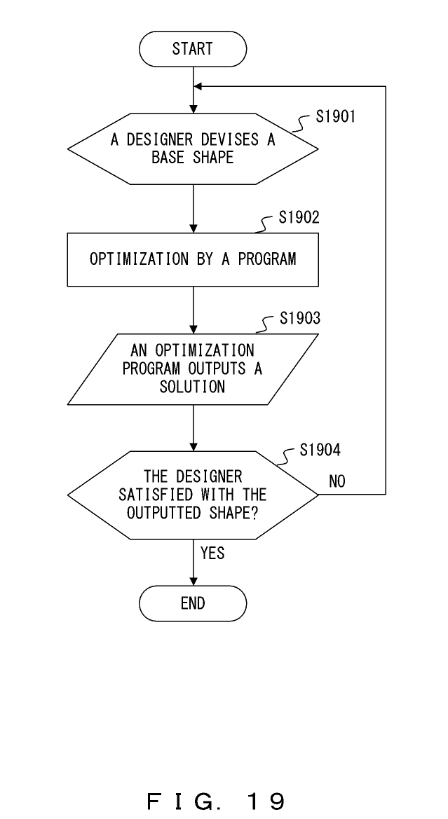

When one point is obtained on the Pareto curved surface as an optimal solution, one set of design parameters is determined in relation to it and then one design shape can be obtained. However, a designer is not always satisfied with the design shape. In such a case, as illustrated in FIG. 19, firstly the designer devises a base shape (step S1901) and performs optimization by a program (step S1902). When the optimization program outputs one solution (step S1903), the designer determines whether an outputted shape corresponding to the solution is satisfactory (step S1904). If it is not satisfactory, it is necessary for the designer to repeatedly devise a new base shape (step S1901) and perform optimization (steps S1902 through S1904).

In such a case, since the multi-objective optimization process alone takes very much time, actually it is difficult even to display an appropriate Optimal Pareto solution and much less there is no design support method for efficiently repeating optimization while determining a design shape and the like based on the optimal solution.

Furthermore, even if an optimal Pareto solution can be obtained, it is necessary to verify whether the optimal Pareto solution is truly optimal for the determination of an optimal design shape. However, since it is difficult to derive an optimal Pareto solution itself, there is no established verification method.

Preferred embodiments of the present invention will be explained below with reference to accompanying drawings.

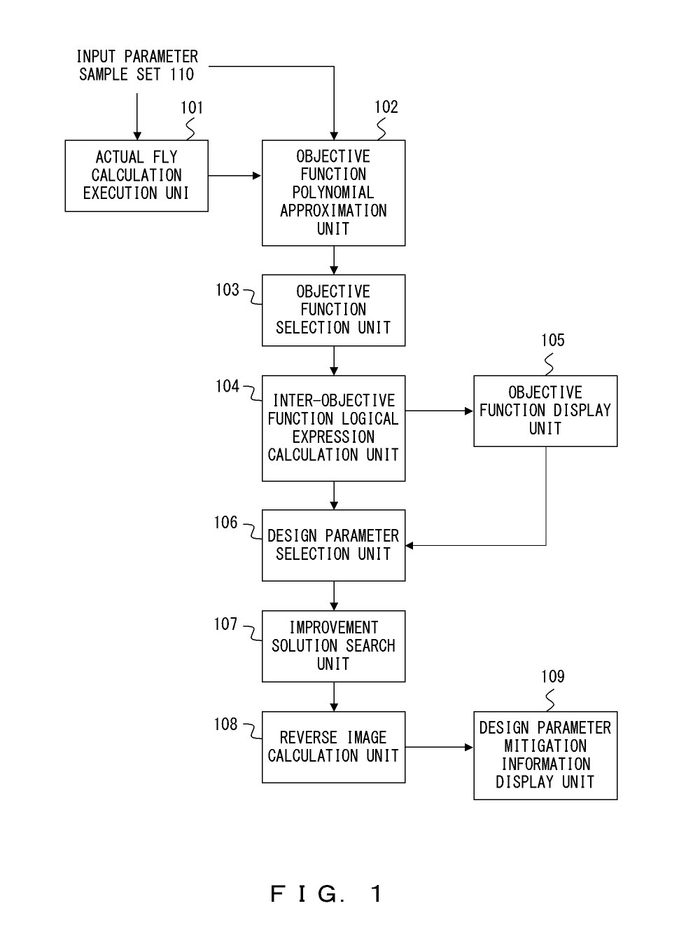

FIG. 1 is the functional block configuration of this preferred embodiment. The actual fly calculation execution unit 101 inputs the input parameter sample sets 110 of the slider shape of a hard disk, applies the fly calculation of a slider to each set and outputs each objective function value. In this case, it is sufficient if the number of input parameter sample sets 110 is at most approximately several hundreds.

The objective function polynomial approximation unit 102 approximates each objective function of a slider shape to each objective function value of each set, calculated by the actual fly calculation execution unit 101 using a polynomial by a multi-regression expression based on multi-regression analysis or the like. Although in this preferred embodiment, an approximation example based on multi-regression analysis is used, another generally known polynomial approximation method, such as various polynomial interpolation methods, a method of increasing the degree of a polynomial and approximating or the like can be also used.

The objective function selection unit 103 enables a designer to select two or three objective functions whose possibility areas should be displayed.

The inter-objective function logical expression calculation unit 104 calculates a logical expression between two arbitrary objective functions selected by the designer in the objective function selection unit 103 on the basis of each objective function polynomial calculated by the objective function polynomial approximation unit 102 and the restraints of each parameter value of the input parameter sample set 110 (input parameter set 108) by an quantifier elimination (QE) method.

The objective function display unit 105 displays the possibility area of an objective function on a computer display, which is not specifically illustrated, on the basis of the logical expression among the arbitrary two or three objective functions selected by the designer in the objective function selection unit 103 that is calculated by the inter-objective function logical expression calculation unit 104. It also displays an improvement solution candidate searched by the improvement solution search unit at the time of a design improvement process, which will be described later.

The design parameter selection unit 106 enables the designer to select two or three design parameters to improve design.

The improvement solution search unit 107 presents an improvement solution to the designer by copying a sample point group outside the possibility area in the coordinate space of the design parameter set selected by the design parameter selection unit 106 onto an objective space, using the approximation polynomial of the two or three objective functions that are obtained by the objective polynomial approximation unit 102 and selected by the objective function selection unit 103 and displaying the result on the objective function display unit 105 when the Optimal Pareto solution displayed by the objective function display unit 105 is not satisfactory.

The reverse image calculation unit 108 performs a reverse image calculation process for calculating a sample point in design parameter space corresponding to the optimal improvement solution when the designer detects a more optimal solution than the optimal Pareto solution among improvement solutions displayed by the objective function display unit 105.

The design parameter mitigation information display unit 109 overlap sample points corresponding to the optimal improvement solution calculated by the reverse image calculation process of the reverse image calculation unit 108 with the possibility area in design parameter space whose coordinate axes are the design parameter set selected by the design parameter selection unit 106 and displays it on a display, which is not specifically illustrated.

The operation of this preferred embodiment having the above configuration is explained below.

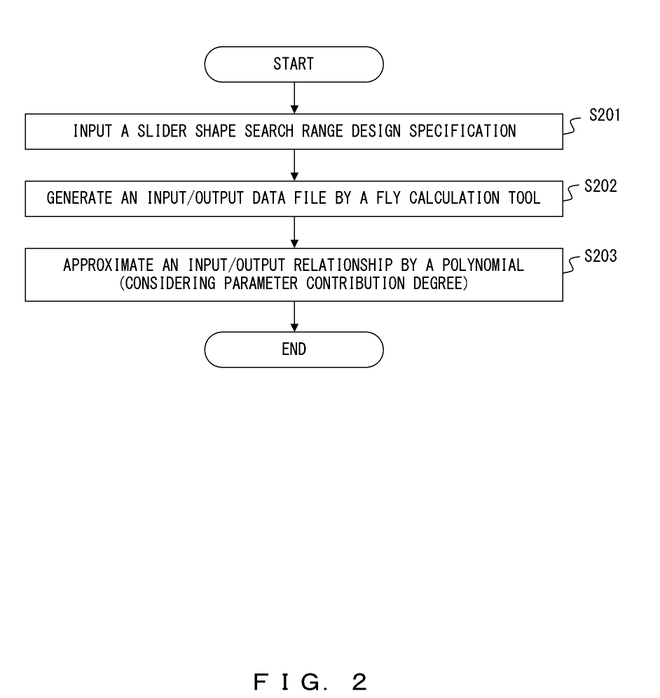

FIG. 2 is an operational flowchart illustrating the processes of the actual fly calculation execution unit 101 and the objective function polynomial approximation unit 102.

Firstly, the actual fly calculation execution unit 101 illustrated in FIG. 1 inputs approximately several hundreds of input parameter sample sets 110 as the design specification of the search range of a slider shape (step S201 in FIG. 2), applies slider fly calculation to each set and outputs each objective function value (step S202 in FIG. 2).

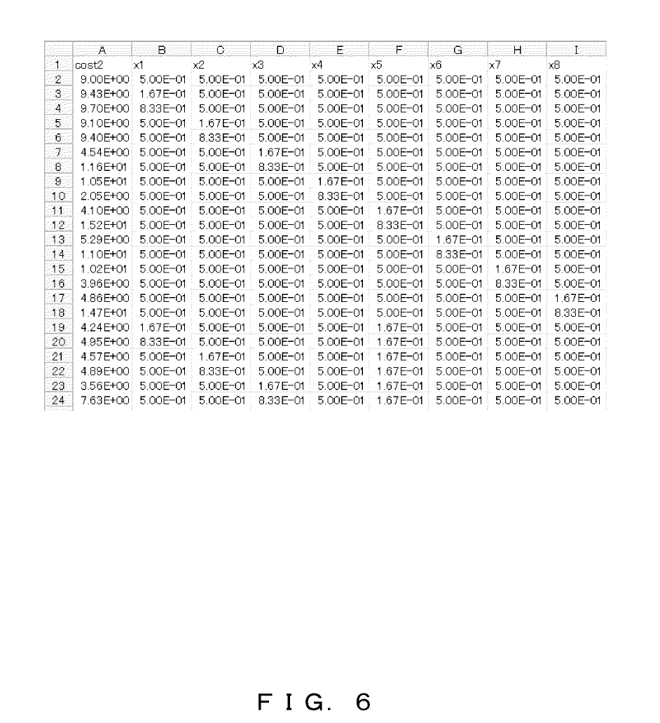

Thus, for example, the data file of input parameter sample sets 110 and their objective function values as illustrated in FIG. 6 is generated. In FIG. 6, values in lines expressed as x1 through x8 are respective input parameter sample sets 110 and values in lines expressed as cost2 are a group of a certain objective function values.

Then, the objective function polynomial approximation unit 102 illustrated in FIG. 1 approximates each objective function of a slider shape subjecting the data file composed of the input parameter sample sets 110 and each calculated objective function value of each set, using a polynomial by a multi-regression expression based on multi-regression analysis or the like (step S203 in FIG. 2).

As a result, an objective function polynomial exemplified below can be obtained.

f1:=99.0424978610709132−6.83556672325811121*x1+14.0478279657713188*x2 −18.6265540605823148*x3−28.3737252180449389*x4−2.42724827545463118 *x5+36.9188200131846998*x6−46.7620704128296296*x7+1.0595888709407 9946*x8+6.50858043416747911*x9−11.3181110745759242*x10−6.354382977 22882960*x11+4.85313298773917622*x12−11.142898807281405*x[13]+35.3 305897914634315*x14−53.2729720194943113*x15; (Mathematical expression 2)

In this case, in slider design there is a tendency that the types of input parameters increase as the work progresses. Sometimes (due to the influence of another parameter) it can be estimated that there is a parameter whose contribution to a certain objective function is low. Therefore, by incorporating a routine for eliminating a parameter whose contribution is low, using multi-regression analysis or the like, approximation by a simpler polynomial becomes possible. When a designer inputs the number of parameters used for analysis, the objective function polynomial approximation unit 102 narrows the number of parameters up to its preset number. By this parameter reduction process, the amount of calculation can be reduced at the calculation time of a QE method, which will be described later.

As a result, the polynomial of an objective function whose number of parameters is reduced, as illustrated below, can be obtained.

f1:=100.236733508603720−.772229409006272793*x1−20.7218054045105654*x3−5.61123555392073126*x5+27.4287250065600468*x6−52.6209219228864030*x7+2.86781289549098428*x8−1.51535612687246779*x11−51.1537286823153181*x15; (Mathematical expression 3)

(The number of variables is reduced from 15 to 8.)

As explained above, in this preferred embodiment, an objective function approximated using a polynomial by multi-regression expression or the like can be obtained, using at most approximately several hundreds of input parameter sample sets. It is because in slider design, there is an initial slider shape at first and then optimization is performed while swinging parameters determining this initial shape in a specified range that an objective function can be approximated by a polynomial thus. In optimization, it is known that in such a local design modification range, sufficiently effective initial optimization can be performed by linear approximation by multi-regression expression or the like.

In this preferred embodiment, a very efficient design support system can be realized by using an objective function that is calculated and mathematically processed thus in the early stage of slider design, more particularly for the determination of a Pareto boundary as explained below.

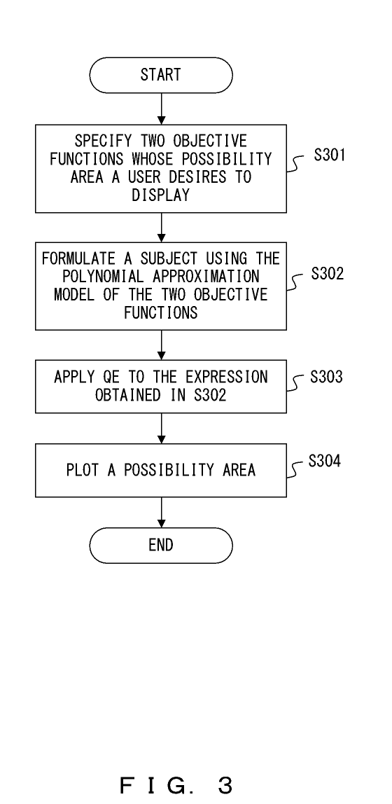

Next, FIG. 3 is an operational flowchart illustrating the processes of the objective function selection unit 103, the inter-objective function logical expression calculation unit 104 and the objective function display unit 105.

Firstly, a designer selects two objective functions whose possibility area is desired to display in the objective function selection unit 103 illustrated in FIG. 1 (step S301 in FIG. 3). These are assumed to be f1 and f2. In this preferred embodiment, three objective functions can be also specified instead of two objective functions.

Then, the inter-objective function logical expression calculation unit 104 illustrated in FIG. 1 formulizes the two (or three) objective functions selected by the objective function selection unit 103, using each objective function approximation polynomial calculated by the objective function polynomial approximation unit 102 and each parameter value constraints of the input parameter sample set 110 (input parameter set 108) (step S302 in FIG. 3). Thus, for example, a mathematical expression 4 exemplified below can be obtained. Although in this formula, the number of parameters is left unreduced 15, the number can be reduced.

y1=f1(x1, . . . , x15), y2=f2(x1, . . . , x15)

F:=∃x₁∃x₂ . . . ∃x₁₅, 0≦x₁≦1 and 0≦x₂≦1 and . . . and 0≦x₁₅≦1

and y₁=f1(x₁, . . . , x₁₅) and y₂=f2(x₁, . . . , x₁₅) (Mathematical expression 4)

(Input parameters x1, . . . , x15 move in the range of 0≦x_i≦1.)

Then, the inter-objective function logical expression calculation unit 104 calculates a logical expression among the two or three objective functions selected by the objective function selection unit 103 by applying a QE method to the value F of Expression (4) (step S303 in FIG. 3). As a result, as exemplified below, input parameters x1 through x15 are erased and the logical expression of the two objective functions y1 and y2 is outputted. In the case of three objective functions, the logical expression of three objective functions y1, y2 and y3 is outputted.

y2 [symbol] /1+1 and y2 [symbol] 2 and y2 [symbol] 2*y1−3 (Mathematical expression 5)

although the details of the QE method are omitted, its processing method is disclosed in a publicly known reference literature by the inventor of the present invention “Actual Calculation Algebraic/Geometric Introduction: Summary of CAD and QE” (Mathematic Seminar, No. 11, pp 64-70) (2007) (co-edited with Hirokazu Anai and Kazuhiro Yokoyama). This preferred embodiment also adopts the processing method without any modification.

Then, the objective function display unit 105 illustrated in FIG. 1 displays the possibility area of the two objective functions on a computer display according to the logical expression between the arbitrary two objective functions, calculated by the inter-objective function logical expression calculation unit 104 (step S304 in FIG. 3).

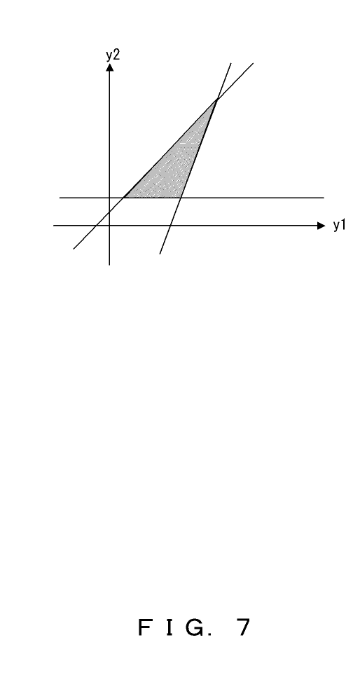

More specifically, the objective function display unit 105 continues to paint over points in which the logical expression of the two objective functions y1 and y2 exemplified in Expression (5) that is calculated by the inter-objective function logical expression calculation unit 104 holds true while sweeping each point on a two-dimensional plotting plane of the two objective functions y1 and y2. As a result, a possibility area can be displayed, for example, in a form as illustrated as a painted area in FIG. 7.

In the case of three objective functions, it is three-dimensionally displayed.

Another specific example of the above-described possibility area display process is explained below.

It is assumed that, as exemplified below, the approximation polynomial of two objective functions is composed of three input parameters x1, x2 and x3.

y1=f1(x1, x2, x3)=x1−2*x2+3*x3+6

y2=f1(x1, x2, x3)=2*x1+3*x2−x3+5 (Mathematical expression 6)

The result of formulating Expression (6) is as follows.

F:=∃ₓ₁∃x₂∃₃; 0≦x₁≦1 and 0≦x₂≦1 and 0≦x₃≦1 and y₁=x₁−2x₂+x₃+6 and y₂=2x₁+3x₂−x₃+5 (Mathematical expression 7)

The result of further applying a QE method to Expression (7) is as follows.

(3*y1+2*y2−35 [symbol] =0 and 3*y1+2*y2−42 [symbol] =0 and y1+3*y2−28 [symbol] =0 and y1+3*y2−35 [symbol] =0)

or (3*y12*y2−28 [symbol] =0 and 3*y1+28y2−35 [symbol] =0 and *y1−y2−7 [symbol] =0 and 2*y1−2 [symbol] =0)

or (2*y1−y2−7 [symbol] =0 and 2*y1−y2−14 [symbol] =0 and y1+3*y2−21 [symbol] =0 and y1+3*y2−28 [symbol] =0) (Mathematical expression 8)

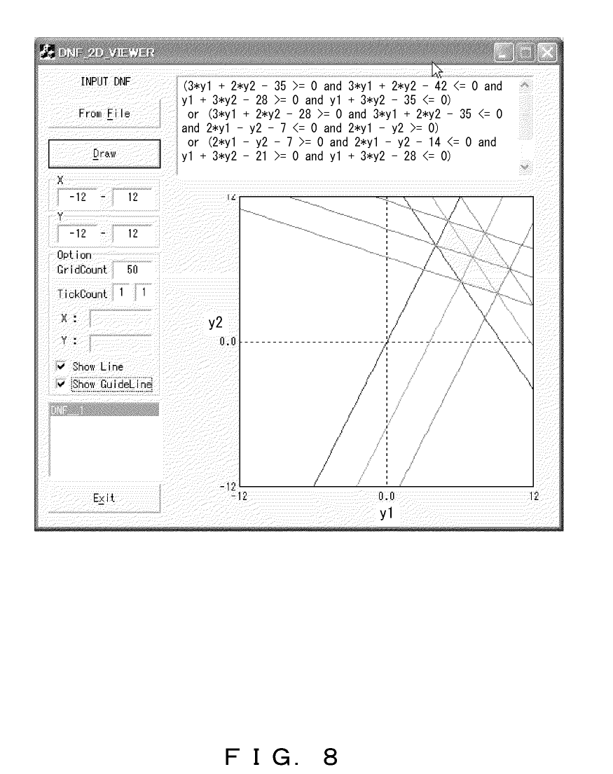

The result of plotting a possibility area according to the logical expression of Expression (8) is, for example, as illustrated in FIG. 8. In FIG. 8, an oblique straight line indicates each logical boundary of the logical expression of Expression (8) and a painted area indicates the possibility area of the two objective functions.

As it is clear from display in FIG. 8, in the painted possibility area, that the Pareto boundary of the two objective functions can be easily recognized intuitively as the boundary of the bottom edge near the coordinate origin and an optimization limit area can be recognized. In the case of three objective functions, although the Pareto boundary becomes a curved surface (Pareto surface), it can be three-dimensionally displayed.

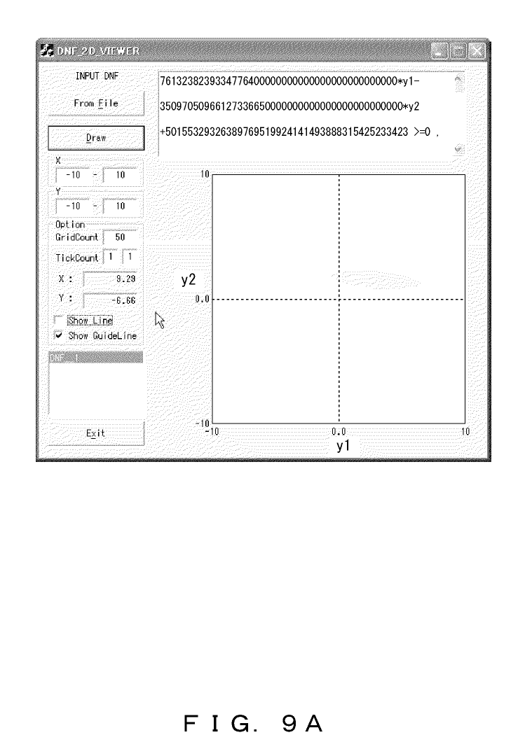

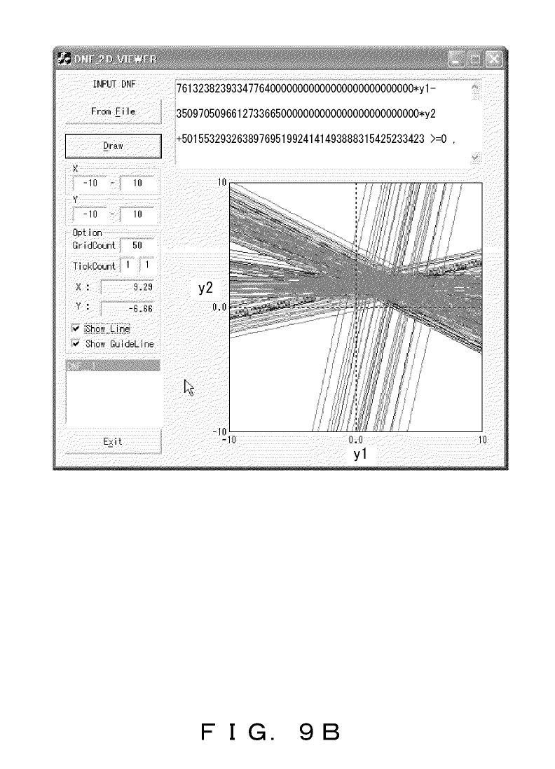

FIG. 9A is a possibility area display example obtained using the input parameter sample set 110 corresponding to an actual slider shape. FIG. 9B is a possibility area display example in the case where the boundary of a logical expression is also displayed. In this example, assuming that the amount of slider fly in low altitude (0 m) and the amount of slider fly in high altitude (4200 m) are the first objective function f1 and the second objective function f2, respectively, their relationship y1 and y2 is expressed in a graph.

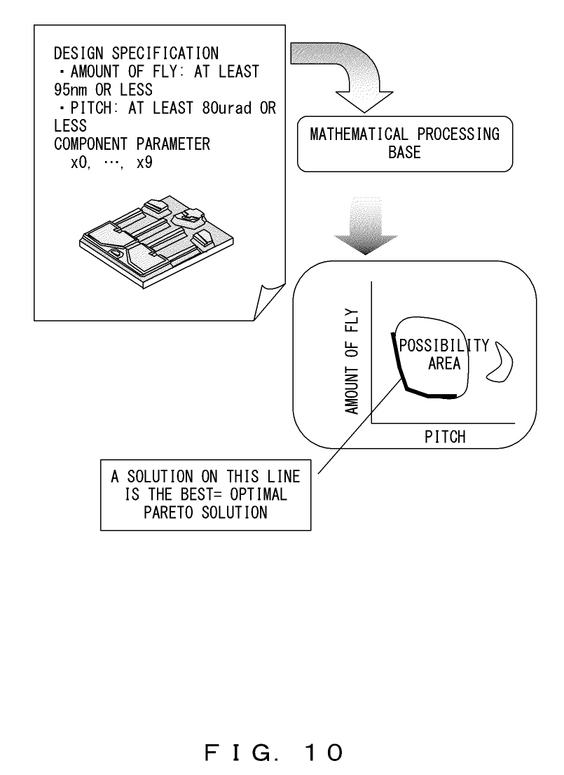

In the above-explained process of this preferred embodiment, as illustrated in FIG. 10, a multi-objective optimization process can be performed on the basis of a mathematical process by polynomial approximation and an optimal Pareto solution can also be mathematically displayed based on QE method. Therefore, an optimal Pareto solution can be easily obtained.

An optimal Pareto solution can be easily displayed emphatically by the objective function display unit 105 emphatically displaying a display point which appears on the utmost left side on each scanning line when painting over points in which the logical expression of the two objective functions calculated by the inter-objective function logical expression calculation unit 104 (Expression (5), (8) or the like) holds true while sweeping each point on a two-dimensional plotting plane of the arbitrary two objective functions. This is a very advantageous feature when compared with the prior art in which it is difficult even to emphatically display an optimal Pareto solution since an optimal Pareto solution is plotted and displayed.

In the above-described possibility area display process, a designer can efficiently specify both a possibility area and a Pareto boundary for each objective function while sequentially specifying two objective functions in the objective function selection unit 103 illustrated in FIG. 1.

Next, the operations of the design parameter selection unit 106, improvement solution search unit 107, reverse image calculation unit 108 and design parameter mitigation information unit 109 that are illustrated in FIG. 1 are explained.

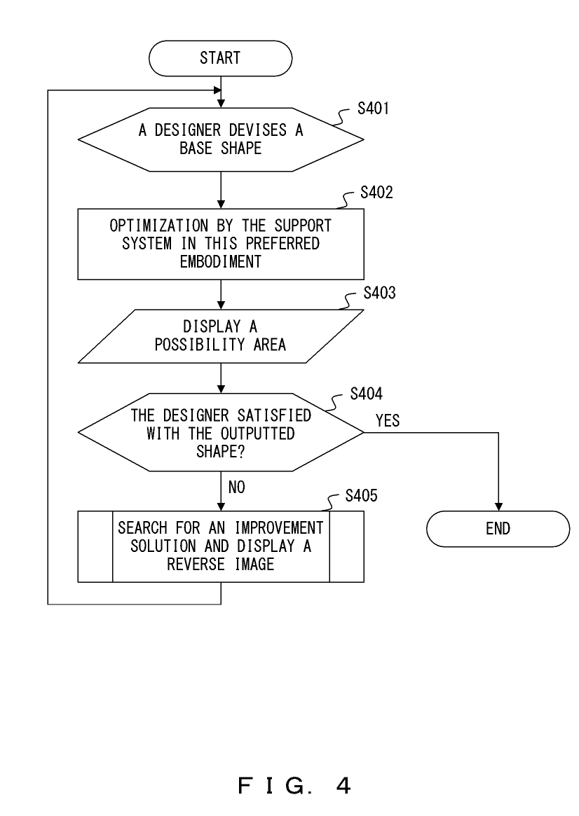

FIG. 4 is an overall operational flowchart illustrating the design support process in the preferred embodiment based on the operations illustrated in the operational flowcharts FIGS. 2 and 3.

Firstly, a designer devises the base shape of the slider of a hard disk or the like and determines a design parameter set corresponding to the base shape (step S401).

Then, the designer determines the design specification of the search range of a slider shape around the determined design parameter set and performs the optimization process by the system of this preferred embodiment illustrated in FIG. 1 (step S402). As a result, the earlier-described optimization process based on the operational charts in FIGS. 2 and 3 and the objective function display unit 105 in FIG. 1 displays the possibility area of the arbitrary two or three objective functions selected by the designer on a display.

The designer determines the optimal solution near a Pareto boundary on this possibility area display and determines whether an outputted design shape is satisfactory while determining a design parameter set displayed in relation to the optimal solution (step S404).

If it is satisfactory, the design shape is adopted and the process is terminated (yes in step S404).

If it is not satisfactory (no in step S404), an improvement solution is searched for and a design parameter set as the reverse image of the improvement solution is calculated and displayed (step S405). This is the greatest feature of the process in this preferred embodiment.

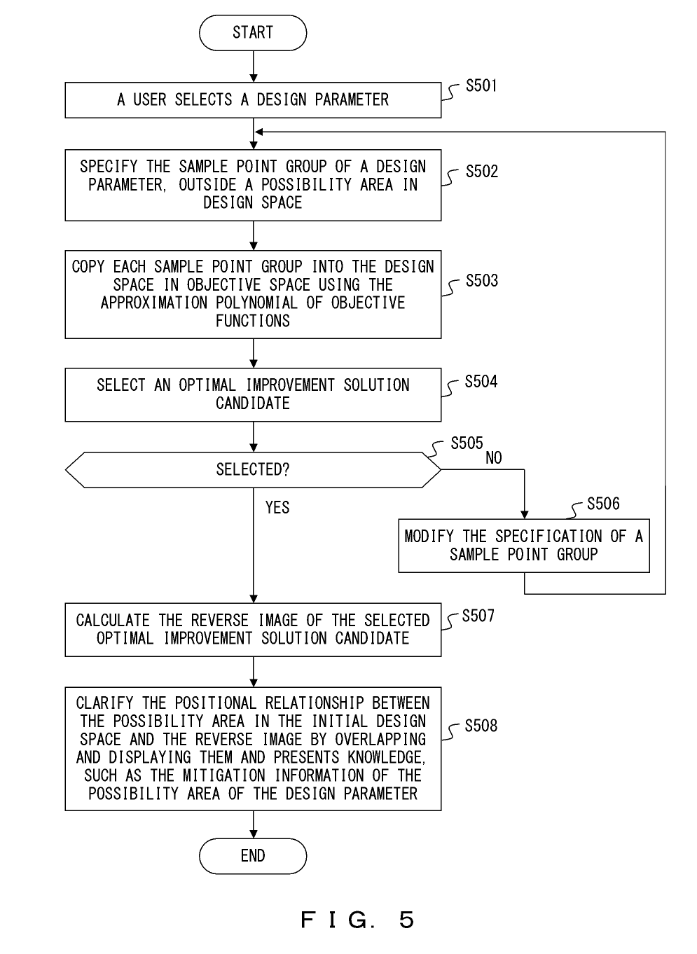

FIG. 5 is a further detailed operational flowchart illustrating the improvement solution search/reverse image display process in step S405 in FIG. 4.

Firstly, the design parameter selection unit 106 in FIG. 1 enables a designer to select two or three design parameters in order to improve design (step S501).

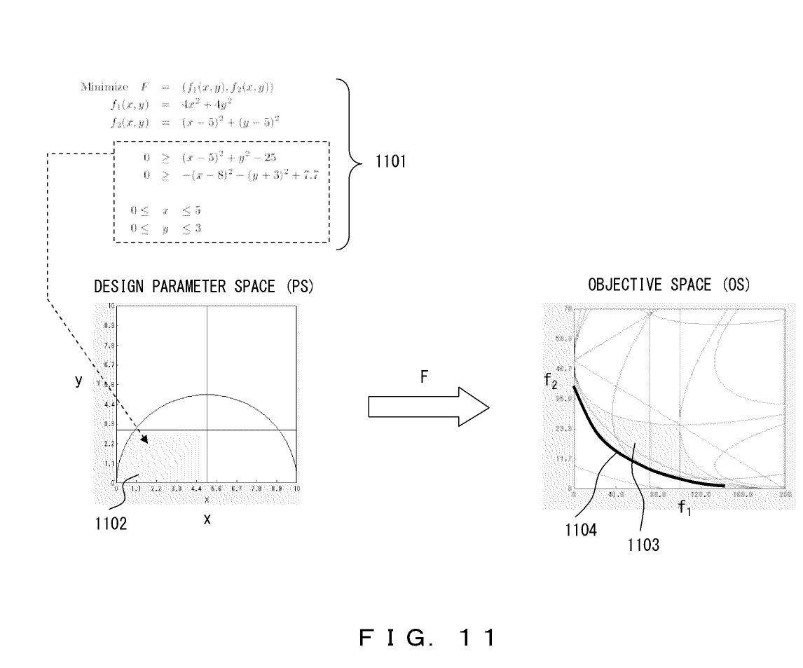

For the purpose of simplifying descriptions it is assumed that x and y are selected as design parameters and objective functions f1 and f2 is formulated with the polynomial, for example, illustrated as 1101 in FIG. 11, using these design parameters. As a result, a painted area 1102 in FIG. 11 is obtained as a possibility area in a two-dimensional design parameter space (PS) determined by the design parameter x and y. These design parameters x and y are optimized by the objective functions f1 and f2. As a result, for example, a painted area 1103 in FIG. 11 is obtained as a possibility area in two-dimensional objective space (OS) determined by the objective functions f1 and f2, and a curved part illustrated as 1104 in FIG. 11 is obtained as a Pareto boundary. These are the results of steps S402 and S403 in FIG. 4.

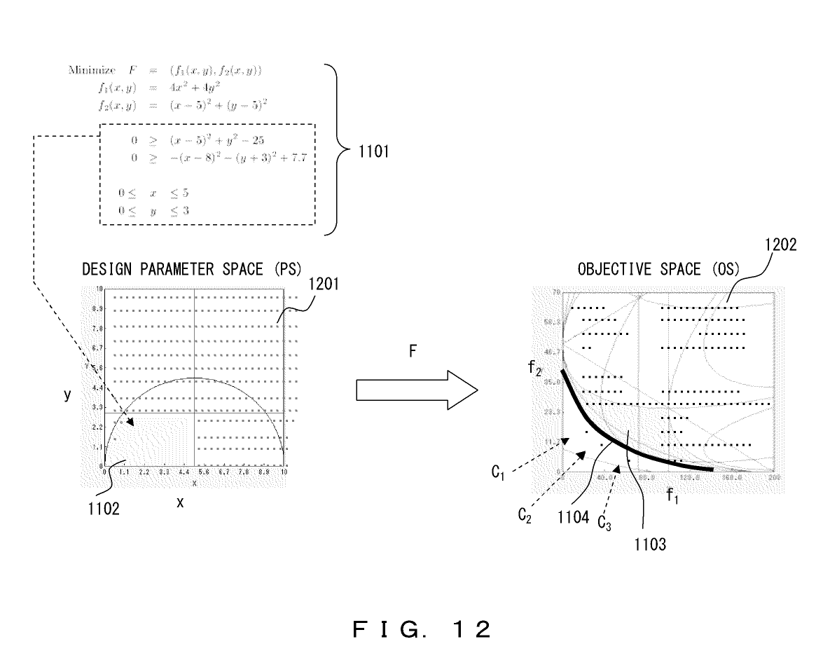

Then, the improvement solution search unit 107 in FIG. 1 specifies a sample point group outside the possibility area in the coordinate space (design parameter space) of the design parameter set selected by the design parameter selection unit 106 (step S502). In an explanatory model in FIG. 11, for example, as illustrated in FIG. 12, a sample point group 1201 is specified in an area other than the possibility area 1102 (the same as 1102 in FIG. 11) of the design parameter space.

Then, the improvement solution search unit 107 copies the specified sample point group in the objective space, using the approximation polynomial of the two or three objective functions that are obtained by the objective function polynomial approximation unit 102 in FIG. 1 and are selected in the objective function selection unit 103 in FIG. 1 and displays the result on the objective function display unit 105 in FIG. 1 (step S503). In an explanatory model in FIG. 11, although the objective function display unit 105 at first displays the possibility area 1103 and the Pareto boundary 1104 in FIG. 11 in the objective space determined by the objective functions f1 and f2, in step S403 in FIG. 4, as a result of step S503, it displays a sample point group 1202 corresponding to a new sample point group 1201 in the design parameter space.

Then, the improvement solution search unit 107 enables the designer to select a sample point which can be an optimal improvement solution candidate, out of the sample point group 1201 displayed by the objective function display unit 105 (step S504). In the example of FIG. 12, sample points C₁, C₂ and C₃ are positioned on a side nearer to the origin than the Pareto boundary 1104 and the designer can recognize a possibility of these points being the more optimal solution of the objective functions f1 and f2 than a solution on the Pareto boundary 1104. As a result, the designer specifies, for example, the sample points C₁, C₂ and C₃ as optimal improvement solution candidates by mouse click or the like.

If the designer can specify an optimal improvement solution candidate (yes in step S505), the reverse image calculation unit 108 in FIG. 1 performs a reverse image calculation process for calculating a sample point in design parameter space corresponding to the optimal improvement solution candidate specified by the designer (step S506). For example, in FIG. 12, the sample point group 1201 in the design parameter space and the sample point group 1202 including C₁, C₂ and C₃ in the objective space are related to each other in step S503. Therefore, in step S506, respective sample points in the design parameter space corresponding to the sample points C₁, C₂ and C3 are selected from the responding points.

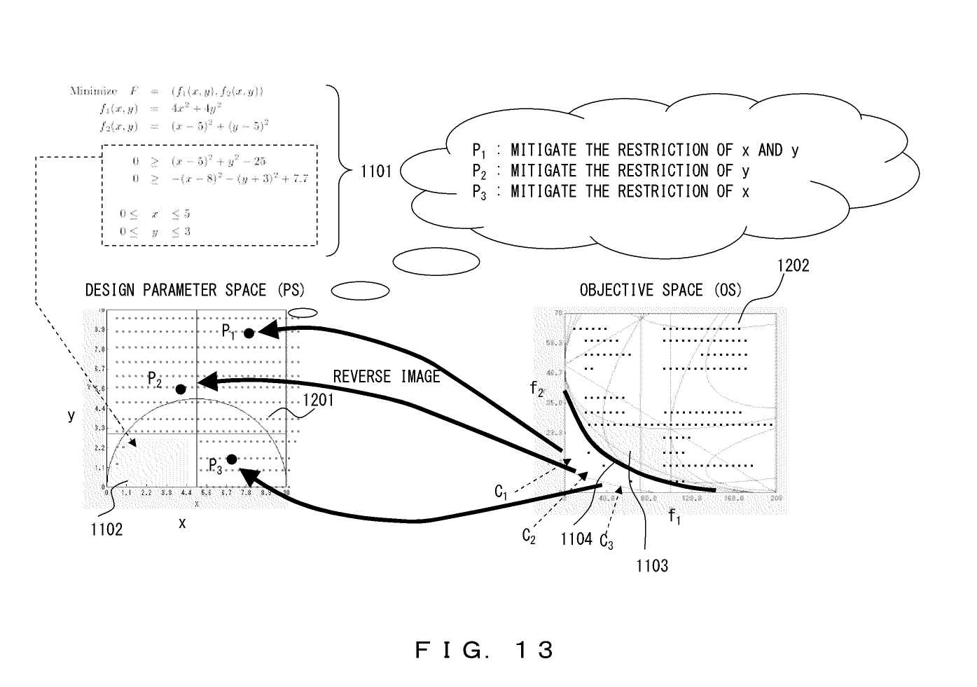

The design parameter mitigation information display unit 109 overlaps a sample point corresponding to the optimal improvement solution calculated by the reverse image calculation process of the reverse image calculation unit 108 with the initial possibility area in design parameter space whose coordinate axes are the design parameter set selected by the design parameter selection unit 106 and displays it on a display or the like (step S507). For example, as illustrated in FIG. 13, sample points P₁, P₂ and P₃ in the design parameter space, corresponding to the optimal improvement solution candidates C₁, C₂ and C₃ specified in the objective space by the designer are displayed together with the possibility area 1102.

When adopting, for example, the design parameter set P₁, the designer can learn from the display that it is OK if the constraints of the value ranges of both the design parameters x and y are mitigated. When adopting, for example, the design parameter set P₂, the designer can learn that it is OK if the constraints of the value range of the design parameter y are mitigated. Furthermore, when adopting, for example, the design parameter set P₃, the designer can learn that it is OK if the constraints of the value range of the design parameter x are mitigated.

After obtaining knowledge of an improvement solution as above in step S405 in FIG. 4, back in step S401 in FIG. 4, the designer can devise a new base shape based on this knowledge and further optimize it.

If the designer cannot specify an appropriate optimal improvement solution candidate in the objective space (no in step S505 in FIG. 5), the improvement solution search unit 107 in FIG. 1 modifies how to specify a sample point group outside the possibility area in the design parameter space in step S502 and specifies a new sample point group (steps S506-S502).

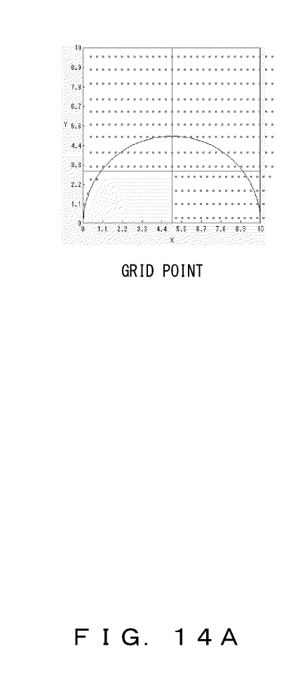

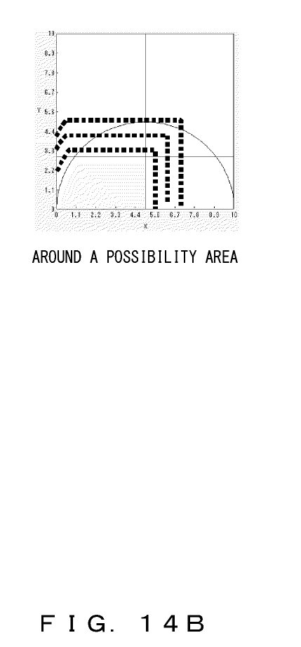

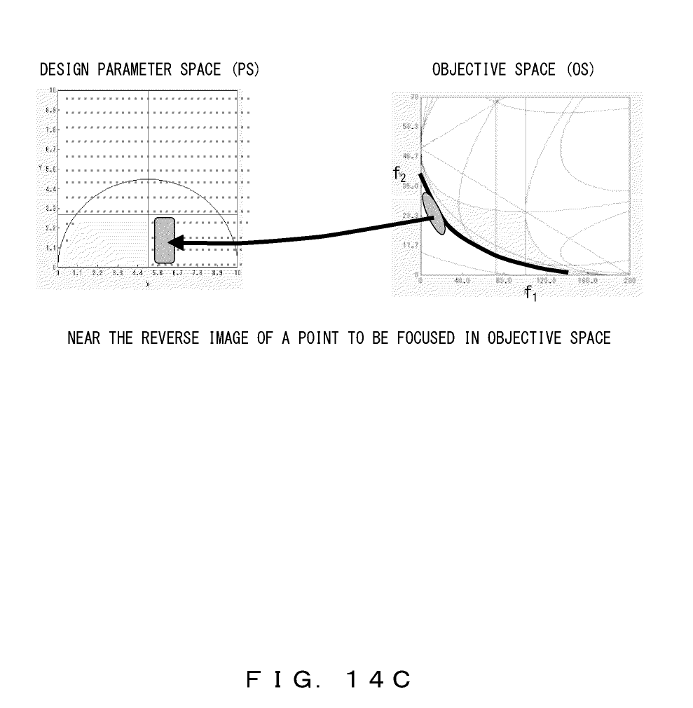

As the modification method of how to specify in step S506, for example, a method of sequentially shortening the distance between grids in a sample point group as illustrated in FIG. 14A, a method of increasing the number of sample point groups toward outside from inside near the possibility area like a contour around the possibility area as illustrated in FIG. 14B, a method of setting a sample point group only in the neighborhood of a reverse image in the focused area of the objective space as illustrated in FIG. 14C and the like can be considered.

As described above, in this preferred embodiment, when the designer cannot obtain a satisfactory solution under the constraints of a design parameter at the time of the first design, the designer can intuitively (visually) learn how to mitigate the design parameter. As a result, knowledge effective in devising the candidate of the initial design parameter value can be obtained.

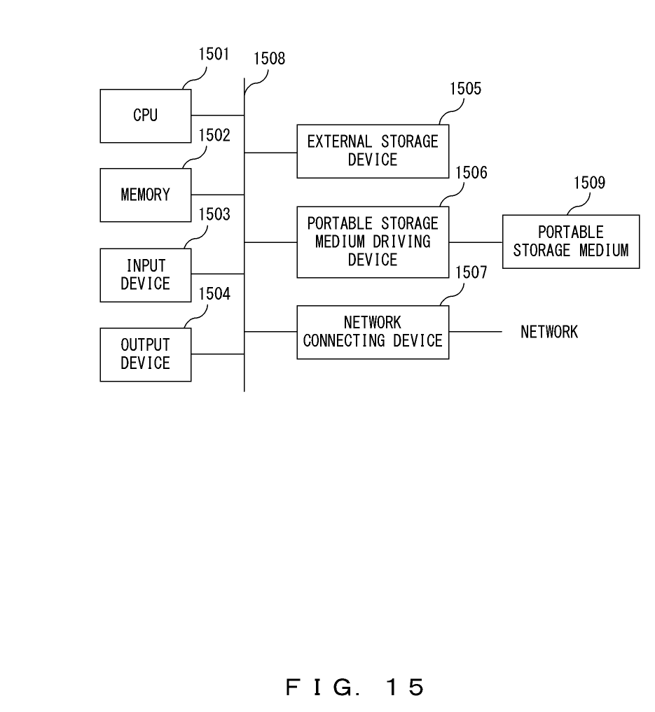

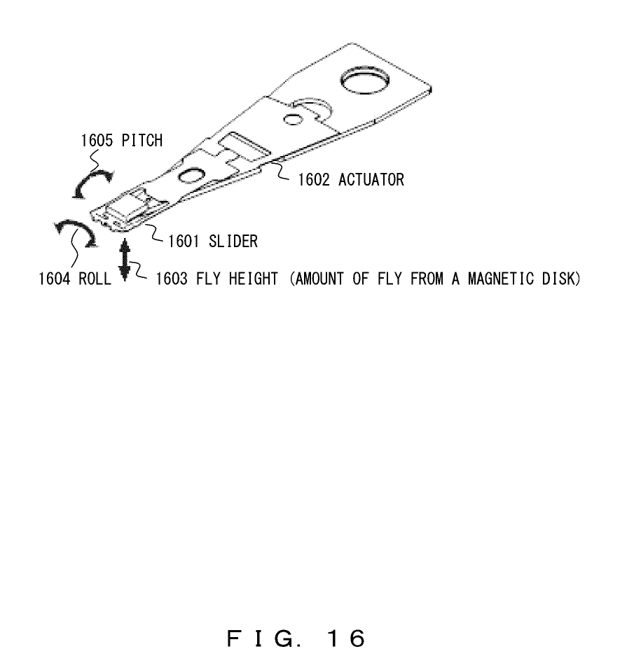

FIG. 15 illustrates an example of hardware configuration of a computer capable of realizing the above-described system.

The computer illustrated in FIG. 15 includes a CPU 1501, memory 1502, an input device 1503, an output device 1504, an external storage device 1505, a portable storage medium driving device 1506 in which a portable storage medium 1509 is inserted and a network connecting device 1507, which are connected to each other by a bus 1508. The configuration illustrated in FIG. 15 is one configuration example of a computer capable of realizing the system. However, the configuration of such a computer is not limited to this.

The CPU 1501 controls the entire computer. The memory 1502 is RAM or the like for temporarily storing a program or data stored in the external storage device 1505 (or the portable storage medium 1509) when executing the program, updating the data and the like. The CPU 1501 controls the entire computer by reading the program into the memory 1502 and executing it.

The input device 1503 includes a keyboard, a mouse and their interface control devices. The input device 1503 detects an input operation by the keyboard, the mouse and the like of a designer and notifies the CPU 1501 of the detection result.

The output device 1504 includes a display device, a printing device and the like and their interface control devices. The output device 1504 outputs data transmitted under the control of the CPU 1501 to the display device and the printing device.

The external storage device 1505 is for example, a hard disk storage device and is mainly used to store various data and programs.

The portable storage medium driving device 1506 accommodates the portable storage medium 1509, such as an optical disk, SDRAM, a compact flash (trademark) and the like and plays the auxiliary role of the external storage device 1505.

The network connecting device 1507 connects communication lines, such as LAN (local area network) or WAN (wide area network).

The system according to this preferred embodiment can be realized by executing the program mounting the functional blocks illustrated in FIG. 1 by the CPU 1501. The program can be recorded, for example, the external storage device 1505 and the portable storage medium 1509 and distributed. Alternatively, the program can be obtained from a network by the network connecting device 1507.

Although in the above-described preferred embodiment, the present invention is implemented as a design support system for supporting the slider design of a hard disk, the present invention is not limited to this and is applicable to various devices for supporting design while performing a multi-objective optimization.

Although in the above-described preferred embodiments, objective functions are mathematically processed, the possibility area of objective space is displayed and the reverse image in design parameter space corresponding to it and the possibility area of comparison target objective space and the like are displayed, the configuration can be such that the possibility area of objective space is displayed by another method for calculating an objective function on the basis of design parameters and the reverse image of the design parameter space, corresponding to it and the like is displayed.

Since according to the disclosed technique, such a design shape that the designer cannot hit upon can be taught from a design parameter sample set calculated in optimization, a hint can be obtained in devising a new base shape.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relates to a showing of the superiority and inferiority of the invention. Although the embodiments of the present inventions have been described in detail, it should be understood that the various changes, substitutions, and alterations could be made hereto without departing from the spirit and scope of the invention. What is claimed is:

1. A multi-objective optimal design improvement support device for supporting determination of an optimal design parameter set by inputting a plurality of design parameter sets, calculating a plurality of objective functions according to a prescribed calculation and performing a multi-objective optimization process of the plurality of objective functions, said device comprising:
an objective space display unit for displaying an area in which an arbitrary objective function value can exist as a possibility area in objective space corresponding to the object function on the basis of the plurality of objective function sets calculated in relation to the plurality of design parameter sample sets;
a design parameter improvement candidate setting unit for setting the design parameter set as a design parameter improvement candidate under improvement constraints other than initial constraints of the design parameter corresponding to the possibility area in design parameter space determined by an arbitrary design parameter according to an instruction of a user;
an improvement solution candidate calculation unit for calculating an objective function corresponding to the design parameter improvement candidate as an improvement solution candidate;
an improvement solution candidate display unit for displaying the improvement solution candidate together with the possibility area in the objective space;
an optimal design parameter improvement candidate acquisition unit for enabling a user to select an optimal improvement solution candidate from the improvement solution candidates displayed by the improvement solution candidate display unit and obtaining a design parameter set in the design parameter space corresponding to the optimal improvement solution candidate as an optimal design parameter improvement candidate; and
a design parameter improvement knowledge/information presentation unit for presenting improvement knowledge/ information of a design parameter on the basis of the optimal design parameter improvement candidate.

2. A multi-objective optimal design improvement support device for supporting determination of an optimal design parameter set by inputting a plurality of design parameter sets, calculating a plurality of objective functions according to a prescribed calculation and performing a multi-objective optimization process of the plurality of objective functions, said device comprising:
a sample set objective function calculation unit for calculating the plurality of objective function sets corresponding to a prescribed number of the design parameter sample sets;
an objective function approximation unit for mathematically approximating the objective functions on the basis of the prescribed number of design parameter sample sets and a plurality of objective function sets calculated in relation to the prescribed number of design parameter sample sets;
an inter-objective function logical expression calculation unit for calculating a logical expression indicating a logical relationship among arbitrary objective functions of the plurality of mathematically approximated objective functions as an inter-objective function logical expression;
an objective space display unit for displaying an area in which the arbitrary objective function value can exist, as a possibility area in objective space corresponding to the arbitrary objective function, according to the inter-objective function logical expression;
a design parameter improvement candidate setting unit for setting the design parameter set as a design parameter improvement candidate under improvement constraints other than initial constraints of the design parameter corresponding to the possibility area in design parameter space determined by an arbitrary design parameter according to an instruction of a user;
an improvement solution candidate calculation unit for calculating an objective function corresponding to the design parameter improvement candidate as an improvement solution candidate using an objective function mathematically approximated by the objective function approximation unit;
an improvement solution candidate display unit for displaying the improvement solution candidate together with the possibility area in the objective space;
an optimal design parameter improvement candidate acquisition unit for enabling a user to select an optimal improvement solution candidate from the improvement solution candidates displayed by the improvement solution candidate display unit and obtaining a design parameter set in the design parameter space corresponding to the optimal improvement solution candidate as an optimal design parameter improvement candidate; and
a design parameter improvement knowledge/information presentation unit for presenting improvement knowledge/ information of a design parameter on the basis of the optimal design parameter improvement candidate.

3. The multi-objective optimal design improvement support device according to claim 1, wherein
said design parameter improvement knowledge/information presentation unit presents a relationship between the design parameter possibility area and the optimal design parameter improvement candidate as improvement knowledge/information of the design parameter by overlapping the design parameter possibility area being an area determined by initial constraints of the design parameter with the optimal design parameter improvement candidate in the design parameter space and displaying them.

4. The multi-objective optimal design improvement support device according to claim 1, further comprising
an improvement constraint modification unit for modifying the improvement constraints of the design parameter improvement candidate setting unit.

5. The multi-objective optimal design improvement support device according to claim 1, wherein
said design parameter is a parameter for determining a shape of a slider unit of a hard disk magnetic storage device.

6. A storage medium on which is recorded a program for enabling a computer for supporting determination of an optimal design parameter set by inputting a plurality of design parameter sets, calculating a plurality of objective functions according to a prescribed calculation and performing a multi-objective optimization process of the plurality of objective functions to execute a process, said process comprising:
objective space display process displaying an area in which an arbitrary objective function value can exist as a possibility area in objective space corresponding to the object function on the basis of the plurality of objective function sets calculated in relation to the plurality of design parameter sample sets;
design parameter improvement candidate setting process setting the design parameter set as a design parameter improvement candidate under improvement constraints other than initial constraints of the design parameter corresponding to the possibility area in design parameter space determined by an arbitrary design parameter according to an instruction of a user;
improvement solution candidate calculation process calculating an objective function corresponding to the design parameter improvement candidate as an improvement solution candidate;
improvement solution candidate display process displaying the improvement solution candidate together with the possibility area in the objective space ( );
optimal design parameter improvement candidate acquisition process enabling a user to select an optimal improvement solution candidate from the improvement solution candidates displayed by the improvement solution candidate display process and obtaining a design parameter set in the design parameter space corresponding to the optimal improvement solution candidate as an optimal design parameter improvement candidate; and
design parameter improvement knowledge/information presentation process presenting improvement knowledge/ information of a design parameter on the basis of the optimal design parameter improvement candidate.

7. The storage medium on which is recorded a program, according to claim 6, wherein
the design parameter improvement knowledge/information presentation process presents a relationship between the design parameter possibility area and the optimal design parameter improvement candidate as improvement knowledge/information of the design parameter by overlapping a design parameter possibility area being an area determined by initial constraints of the design parameter with the optimal design parameter improvement candidate in the design parameter space and displaying them.

8. The storage medium on which is recorded the program, according to claim 6, further comprising
improvement constraint modification process modifying the improvement constraints in the design parameter improvement candidate setting.

9. The storage medium on which is recorded the program, according to claim 6, wherein
the design parameter is a parameter for determining a shape of a slider unit of a hard disk magnetic storage device.
